(19) United States
(12) Patent Application Publication
(10) Pub. No.: US 2007/0005184 A1
(43) Pub. Date: Jan. 4, 2007

(54) Paper processing apparatus

(75) Inventor: Yoshihiro Yamamoto, Isehara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/384,265

(22) Filed: Mar. 21, 2006

(30) Foreign Application Priority Data
Jun. 29, 2005 (JP) 2005-190678

(51) Int. Cl. G06F 7/00

(52) U.S. Cl. 700/228

(57) ABSTRACT

The present invention provides a paper processing apparatus including a gate device having a driver for rotating a gate to a conveyance position according to classifying information of paper, a plate supported by a shaft to be rotated synchronously with the rotation of the gate and a plate detecting part for detecting the plate, and a judging part for judging the operation of the gate based on the detection result of the plate detecting part.

### CROSS-REFERENCE TO RELATED APPLICATIONS

This application is based upon and claims the benefit of priority from prior Japanese Patent Application No. 2005-190678, filed Jun. 29, 2005, the entire contents of which are incorporated herein by reference.

### BACKGROUND OF THE INVENTION

1. Field of the Invention The present invention relates to a paper processing apparatus for classifying paper provided with classifying information into accumulation boxes based on the classifying information.

2. Description of the Related Art Conventionally, a paper processing apparatus for processing paper, such as a mail automatic reading and sorting machine and a mail aligning and stamping machine comprises about 400 pieces at most of accumulation boxes (hereinafter it will be referred to as a stacker) or accumulation bases. These stackers and accumulation bases are provided with a diverter gate for sorting the paper. Since the diverter gate is an expendable part, malfunction is increased according to the increase of the number of driving. Therefore, an operation confirming work is indispensable for the stable operation of the apparatus.

For the operation confirming work, first, an operator sets the apparatus into the maintenance mode. Next, while driving the diverter gate, the operator judges the malfunction by the visual observation and the operation noise.

For simplifying this operation confirming fork, for example, Jpn. Pat. Appln. KOKAI Publication No. 8-91690 discloses a method for automatically monitoring the operation of the diverter gate. According to the method, during the operation of the diverter gate, an image is taken continuously by a ITV camera for detecting the conveyance abnormality according to the change of the paper to be conveyed according to the time.

However, according to the method, correct operations of the diverter gates of an enormous number cannot be confirmed in a short time.

### BRIEF SUMMARY OF THE INVENTION

The present invention has been achieved for solving the above-mentioned problems, and an object thereof is to provide a paper processing apparatus capable of confirming the malfunction of a gate easily in a short time.

A paper processing apparatus of the present invention comprises: a rotatable gate which is disposed in a conveyance path for conveying paper, and which converts the conveyance direction of the paper according to classifying information of the paper and sorts the paper, a shaft which rotatably supports the gate, a driver which rotates the gate to the conveyance position according to the classifying information of the paper by rotating the shaft, a plate supported by the shaft so as to be rotated synchronously with the rotation of the gate, a plate detecting part which detects the plate, and a judging part which judges the operation of the gate based on the detection results of the plate detecting part.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external appearance diagram showing an example of a paper processing apparatus of the present invention;

FIG. 2 is an external appearance diagram showing an example of a paper processing apparatus of the present invention;

FIG. 3 is a block diagram related to a control part of a paper processing apparatus of the present invention;

FIG. 4 is an external appearance diagram showing a configuration of an example of a diverter gate device;

FIG. 5 is an external appearance diagram showing a configuration of an example of a diverter gate device;

FIG. 6 is an external appearance diagram showing a configuration of an example of a diverter gate device;

FIG. 7 shows an operation timing of a diverter gate; and

FIG. 8 is a flow chart showing an example of a malfunction diagnosis method for a diverter gate in a paper processing apparatus of the present invention.

### DETAILED DESCRIPTION OF THE INVENTION

Hereinafter, embodiments of the present invention will be explained with reference to the drawings.

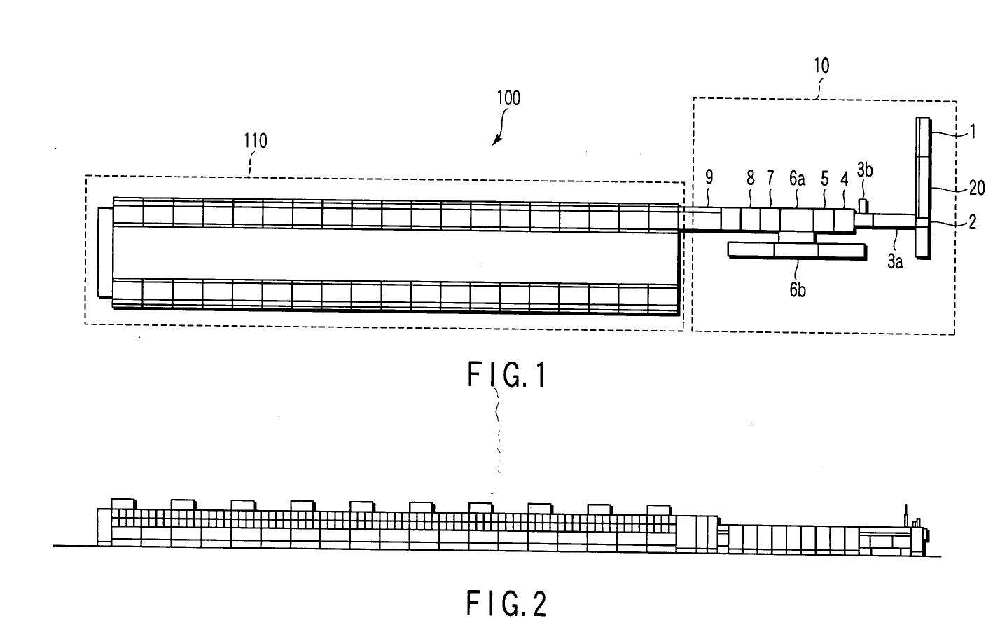

FIGS. 1 and 2 are external appearance diagrams showing an example of a paper processing apparatus of the present invention.

FIG. 1 is a plan view and FIG. 2 is a front view of FIG. 1.

A paper processing apparatus 100 comprises a paper supplying and recognizing part 10 for reading and recognizing a conveyance path for conveying paper, and delivery classifying information mentioned on the paper. Furthermore, it comprises a stacker accumulation part 110 for classifying the paper based on the delivery classifying information recognized by the paper supplying and recognizing part 10.

As to the paper not recognized by the above-mentioned paper supplying and recognizing part 10, the image information showing the delivery classifying information can be sent to a video coding system (hereinafter it is referred to as the VCS). If an operator inputs the delivery classifying information of the paper based on the image information, a bar code can be printed on the paper by an ink jet printer (hereinafter it is referred to as the IJP) based on the delivery classifying information during the online process. Thereafter, the paper not recognized can be accumulated on the above-mentioned stacker accumulation part 110 based on the bar code information.

The paper supplying and recognizing part 10 comprises a supplying part 1 for collectively supplying the paper to be processed, a taking out part 2 for taking out pieces of the paper one by one for sending the same to the conveyance path, a mechanism detecting part 3a, an excluding accumulation part 3b, a pre bar code reading part 4, a character recognizing part 5, delay conveyance paths 6a, 6b, a IJP printing part 7, a verify bar code reading part 8, a stem part 9, and an operate panel 20.

In the apparatus 100, when the apparatus is driven by turning on a starting switch of the operate panel 20 (not shown) with the paper set on the supply part 1, the pieces of paper are taken out from the taking out part 2 one by one.

The mechanism detecting part 3a can detect paper with a foreign substance introduced such as coins, keys, caps of bottles, and seals, and paper out of a standard size out of the taken out paper and exclude the same to the excluding accumulation part 3b. The paper not excluded and to be supplied can be conveyed to the pre bar code reading part 4 and the character recognizing part 5.

The pre bar code reading part 4 and the character recognizing part 5 read and recognize the delivery classifying information such as the bar code, the postal code and the address, written on the paper.

The delay conveyance path 6a is a conveyance part for ensuring the time for the recognition in the character recognizing part 5. Moreover, the delay conveyance path 6b is also a conveyance part for producing the processing time of the VCS process of the paper not read out in the character recognizing part 5. According to the VCS process, an image of the paper is displayed on a monitor while conveying the paper in the delay conveyance path 6b so that an operator can input the delivery classifying information.

The IJP printing part 7 can convert the delivery classifying information set based on the pre bar code reading part 4, the character recognizing part 5 or the VCS keyboard information into a bar code of a special format. Moreover, the printed content can be rechecked by the verify bar code reading part 8.

Thereafter, the control part determines the destination stacker and operates a gate (not shown) of the stem part 9 for accumulating the paper to the stacker based on the determination result of this destination stacker, for sorting to each stage. The sorted paper is conveyed to the stacker accumulation part 110 so as to be guided by the operation of the diverter gate provided at the inlet of the stacker according to the decided destination stacker and accumulated in the stacker.

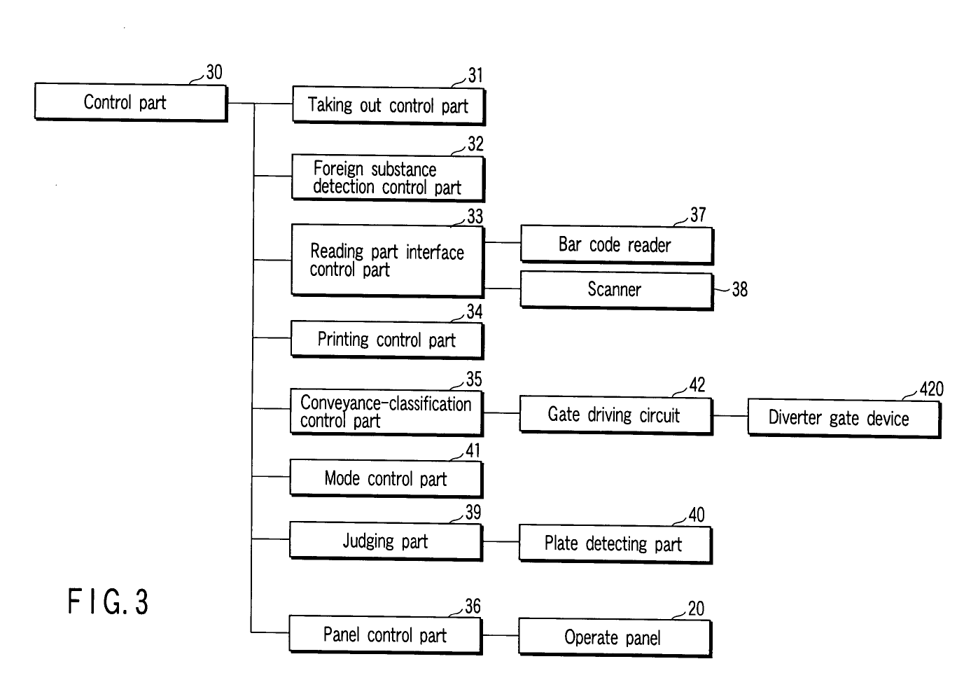

FIG. 3 is a block diagram related to the above-mentioned control part.

A control part 30 controls a taking out control part 31 for controlling the periphery of the supply and taking out part, a foreign substance detection control part 32 for excluding the paper with a foreign substance introduced, a reading part interface control part 33 for trading the delivery classifying information of the paper, a printing control part 34 for bar code printing of the information by the IJP, a conveying and classifying control part 35 for conveying and accumulating the paper in a decided stacker, a mode control part 41 for switching the operation mode of the apparatus such as the drive mode and the maintenance mode, a judging part 39 for judging the malfunction of the periphery of the diverter gate at the time of the maintenance mode, and a panel control part 36 for displaying the paper accumulation information and the apparatus abnormality information on the operate panel.

The reading part interface control part 33 sends the paper read out data in the bar code reader 37 and the paper read out data in the scanner 38 each to the control part 30. Here, according to the data judgment and decision on the conveyance and classification of the paper, the decision results are sent to the conveying and classifying control part 35 as the conveyance-classification information.

The conveying and classifying control part 35 operates various kinds of gates such as the gate of the above-mentioned stem part 9 and a diverter gate device 420 using a gate driving circuit 42 based on the conveyance-classification information.

The judging part 39 judges the malfunction in the periphery of the diverter gate device according to the detection signal from the plate detection part 40 mounted to the diverter gate device. The control part 30 controls the panel control part 36 based on the judgment result so as to display the malfunction in the periphery of the diverter gate device on the operate panel 20.

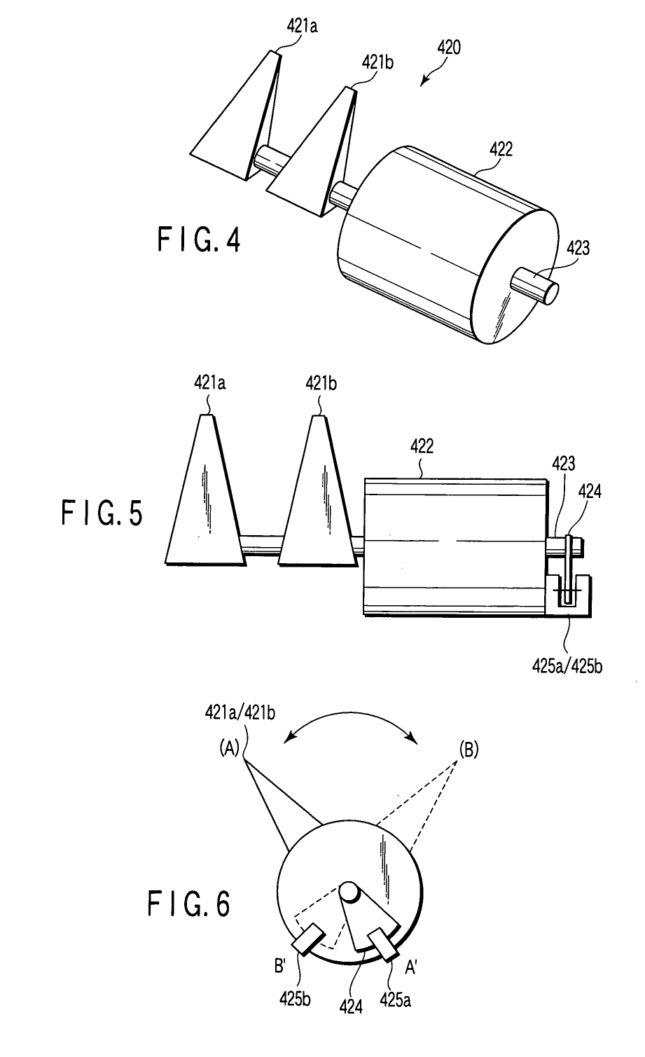

The configuration and the operation of an example of the diverter gate device used in the present invention will be explained with reference to FIGS. 4 to 6.

FIG. 4 is an external appearance diagram of the diverter gate device 420. Here, the plate and the plate detection part are omitted. FIG. 5 is a front view of the diverter gate device 420, and FIG. 6 is a side view thereof.

The diverter gate device 420 is provided with a rotary solenoid 422 as the driver. A shaft 423 projecting from one side surface of the rotary solenoid 422 is provided with diverter gates 421a, 421b disposed with a predetermined interval, set according to the length in the conveyance direction of the paper to be conveyed. The above-mentioned rotary solenoid 422 rotates the diverter gates 421a, 421b by a predetermined angle in the position (A) direction by applying a positive voltage (+) to a coil (not shown) configuring the solenoid, and rotates the diverter gates 421a, 421b by a predetermined angle in the position (B) direction by applying a negative voltage (−). Moreover, the rotary solenoid has the shaft 423 rotated by a predetermined angle by applying a positive voltage (+) or a negative voltage (−) as mentioned above, however, the shaft 423 is not moved in the front and rear direction in the shaft direction.

Furthermore, a plate 424 is supported rotatably by the shaft 423 projecting from the other side surface of the rotary solenoid 422 so as to be moved according to the rotation of the shaft 423. According to the diverter gate device 420, the plate 424 is provided to the opposite side of the diverter gates 421a, 421b with respect to the shaft 423 center. When the diverter gates 421a, 421b are moved counterclockwise from the position B to the position A by applying a positive voltage (+) to the rotary solenoid, the plate 424 can be moved clockwise from the position on the opposite side of the position B with respect to the shaft center to the position on the opposite side of the position A with respect to the shaft center.

Moreover, a first plate detecting part 425a capable of detecting the plate 424 moving to a position opposite to the position A with respect to the shaft center and a second plate detecting part 425b capable of detecting the plate 424 moving to a position opposite to the position B with respect to the shaft center are provided on the above-mentioned other side surface as the plate detecting part 40 for detecting the plate 424 to move as mentioned above. The first plate detecting part 425a and the second plate detecting part 425b can be composed of an optical sensor comprising for example a pair of a light projector and a light receiver. For example, as shown in FIG. 5, the plate 424 can be disposed so as to pass between the light projector and the light receiver of the first plate detecting part 425a, and between the light projector and the light receiver of the second plate detecting part 425b.

Moreover, the plate 424 may be made of a non transmissible material so as to be detected by the first plate detecting part 425a and the second plate detecting part 425b. The first plate detecting part 425a and the second plate detecting part 425b may not necessarily be an optical detection sensor. For example, with a part of the plate made of a magnetic substance, a magnetic sensor for detecting the magnetic substance can be used.

Next, with reference to FIG. 6, the operation of the above-mentioned diverter gate device 420 will be explained. The diverter gates 421a, 421b in the initial position are in a state present at the position A with a positive voltage applied to the coil.

In the explanation below, the expression of “applying a voltage to the coil” will be substituted by the expression of “applying a voltage to the rotary solenoid”.

The plate 424 in the initial state can be detected by the first plate detecting part 425a . When a positive voltage of a predetermined pulse width is applied, the rotary solenoid can move the diverter gates 421a, 421b to the position A and move the plate 424 to the position A′ and maintain the state even if the voltage supply is stopped.

Next, when the shaft 423 is rotated by the application of a negative voltage to the rotary solenoid 422, the diverter gates 421a, 421b are moved to the position B shown by the broken line so as to be maintained in the state even if the voltage supply is stopped. At this time, the plate 424 shown by the broken line can be detected by the plate detecting part 425b.

Accordingly, the switching operation of the diverter gates 421a, 421b can be detected.

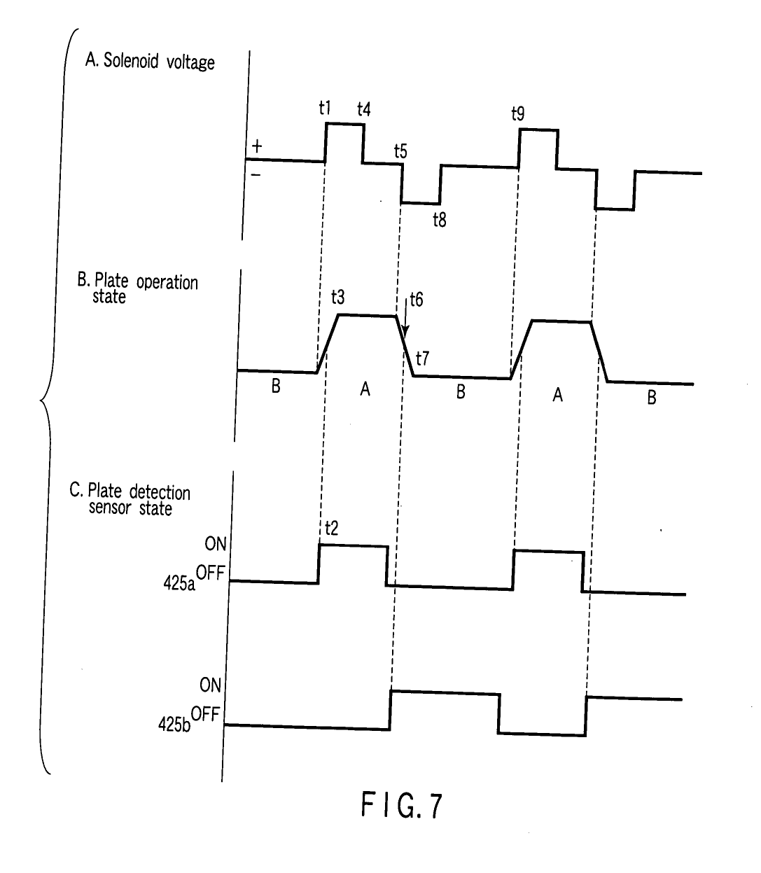

Next, with reference to FIG. 7, the operation timing of the diverter gate will be explained.

FIG. 7A shows the voltage waveform to be applied to the rotary solenoid. FIG. 7B shows the operation state of the plate 424 moving between the positions A′-B′ according to the voltage applied to the rotary solenoid. FIG. 7C shows the state of the plate detecting parts 425a, 425b.

When a positive voltage (+) is applied to the rotary solenoid 420 (timing t1), the plate 424 is moved from the position B′ to the position A′. At this time, the plate 424 is detected at timing t2 with the end part thereof passing by the plate detecting part 425a so that an on (ON, detection state) signal is outputted from the plate detecting part 425a. The plate 424 is further moved so as to reach the position A′ shown by the solid line at timing t3. Although the solenoid voltage is turned off (OFF) at timing t4, the position A′ of the plate 424 is maintained.

When a negative voltage (−) is applied to the rotary solenoid 420 (timing t5), the plate 424 is moved from the position A′ to the position B′. At this time, the plate 424 is detected at timing t6 with the end part thereof passing by the plate detecting part 425b so that an on signal is outputted from the plate detecting part 425b . The plate 424 is further moved so as to reach the position B′ shown by the broken line at timing t7. Although the solenoid voltage is turned off at timing t8, the position B′ of the plate 424 is maintained.

Since the operation of moving the plate 424 between the positions A′-B′ is the same for timing t9 and thereafter, explanation is omitted. Accordingly, by repeatedly applying the solenoid voltage for moving the plate 424 and furthermore, monitoring the “ON”/“OFF” state of the plate detecting parts 425a, 425b, whether or not the diverter gates 421a, 421b are operated normally can be judged.

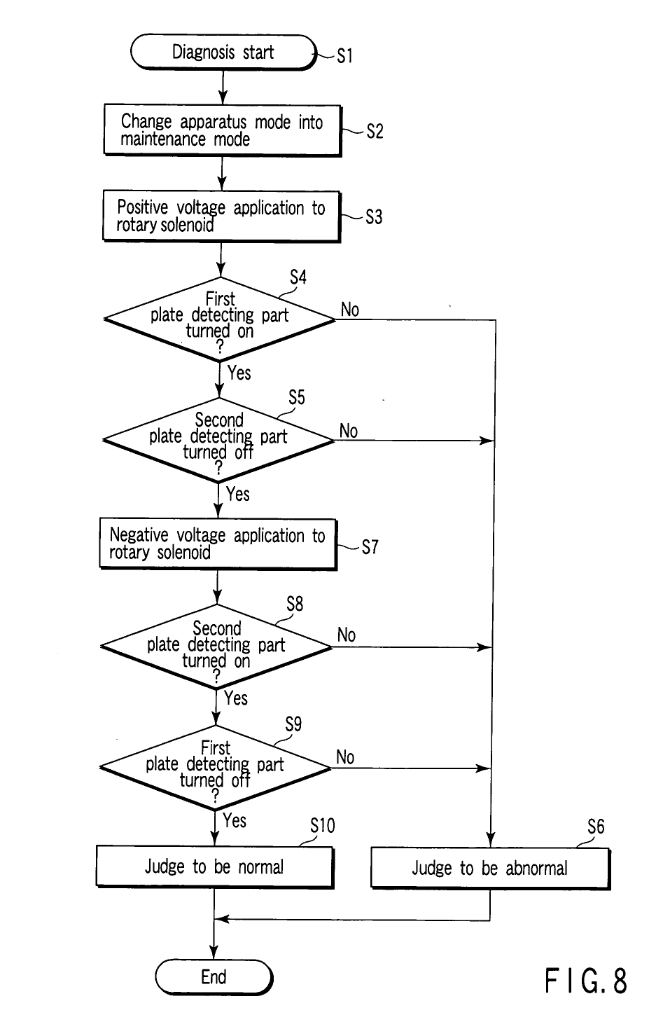

FIG. 8 is a flow chart showing an example of a malfunction diagnosis method for a diverter gate in a paper processing apparatus of the present invention.

First, the mode of the apparatus 100 is changed to the maintenance mode (step S1).

Next, a positive voltage (+) is applied to the rotary solenoid (step S2).

Whether or not the first plate detecting part 425a outputs “ON” is judged (step S4).

In the case where the first plate detecting part 425a outputs “ON”, whether or not the second plate detecting part 425b is “OFF” is judged (step S5).

On the other hand, in the case where the first plate detecting part 425a is in the “OFF” state, it is judged to be abnormal by the judging part 39 (step S6).

In the case where the second plate detecting part 425b is “OFF”, subsequently, a negative voltage (−) is applied to the rotary solenoid (step S7).

Thereafter, whether or not the second plate detecting part 425b outputs “ON” is judged (step S8).

In the case where the second plate detecting part 425b outputs “ON”, whether or not the first plate detecting part 425a is “OFF” is judged (step S9).

On the other hand, in the case where the second plate detecting part 425b is in the “OFF” state, it is judged to be abnormal (step S6).

In the case where the first plate detecting part 425a is “OFF”, it is judged to be normal.

In the case where both the first plate detecting part 425a and the second plate detecting part 425b are in the “OFF” state, or in the case where the “ON”/“OFF” of the first plate detecting part 425a and the second plate detecting part 425b is not changed when the voltage applied to the rotary solenoid is changed for example from a positive voltage (+) to a negative voltage (−), it is considered to be the operation abnormality of the diverter gates 421a, 421b, or the abnormality of the first plate detecting part 425a and the second plate detecting part 425b so as to be judged as the malfunction by the judging part 39.

Or in the case where both the first plate detecting part 425a and the second plate detecting part 425b are in the “ON” state, it is considered to be the abnormality of the plate detecting part so as to be judged as the malfunction by the judging part 39. For example, in the case where garbage, dusts, or the like are stagnated on at least one of the first plate detecting part 425a and the second plate detecting part 425b so as to block between the light projector and the light receiver, an ON signal can always be outputted.

In the real diverter gate analysis, by carrying out the “ON”/“OFF” operation of the diverter gate for a plurality of times successively for a plurality of diverter gates, the operation comparison confirmation can be carried out.

Accordingly, by use of the present invention, malfunction of the diverter gate can be diagnosed easily in a short time by providing a sensor for detecting the diverter gate at the diverter gate initial position and a position after the operation and judging the sensor output at the time of operating the diverter gate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A paper processing apparatus comprising:
a rotatable gate which is disposed in a conveyance path for conveying paper, and which converts the conveyance direction of the paper according to classifying information of the paper and sorts the paper,
a shaft which rotatably supports the gate,
a driver which rotates the gate to the conveyance position according to the classifying information of the paper by rotating the shaft,
a plate supported by the shaft so as to be rotated synchronously with the rotation of the gate,
a plate detecting part which detects the plate, and
a judging part which judges the operation of the gate based on the detection results of the plate detecting part.

2. The paper processing apparatus according to claim 1, wherein the gate is a diverter gate.

3. The paper processing apparatus according to claim 1, wherein the driver is composed of a rotary solenoid which rotates the shaft in one direction by application of a positive voltage, rotates the shaft in a direction opposite to the direction by application of a negative voltage, and does not move the shaft in the front and rear direction in the shaft direction by application of a positive voltage or a negative voltage.

4. The paper processing apparatus according to claim 1, wherein the driver is composed of the rotary solenoid, which rotates the shaft in one direction to an angle until the gate reaches a first conveyance position and maintains the state by application of a positive voltage of a predetermined pulse width, rotates the shaft in a direction opposite to the direction to an angle until the gate reaches a second conveyance position and maintains the state by application of a negative voltage of a predetermined pulse width, and does not move the shaft in the front and rear direction by application of a positive voltage or a negative voltage.

5. The paper processing apparatus according to claim 1, wherein the plate detecting part comprises a first plate detecting part capable of detecting the rotation of the plate when a positive voltage is applied, and a second plate detecting part capable of detecting the rotation of the plate when a negative voltage is applied.

6. The paper processing apparatus according to claim 5, wherein the judging part makes judgment based on both of the detection result of the first plate detecting part and the detection result of the second plate detecting part.
